(19) United States
(12) Patent Application Publication
(10) Pub. No.: US 2003/0183085 A1
(43) Pub. Date: Oct. 2, 2003

(54) Air conditioner filter monitoring apparatus

(76) Inventor: Ashton Alexander, Lovelady, TX (US)

Correspondence Address: Kenneth D. Baugh, Attorney at Law, 2413 Blodgett, Houston, TX, 77004, US

(21) Appl. No.: 10/112,111

(22) Filed: Apr. 1, 2002

(51) Int. Cl. B01D 46/46

(52) U.S. Cl. 96/421; 95/19

(57) ABSTRACT

A filter monitoring apparatus 10 is provided for determining when an air filter 12 in an air conditioning and heating system 14 is clogged. The monitoring apparatus 10 includes an air pressure sensing switch 28 including an actuating arm 34 which monitors air flow through the filter 12 and closes a switching member 30 when the air flowing through the filter falls below a predetermined level. When the switching member 30 closes an activation signal is fed from a power source 24 to activate a horn 26. Once the horn 26 is activated a predetermined sound is transmitted which indicates the air filter 12 is clogged or dirty and should be changed.

### TECHNICAL FIELD

This invention relates to an air conditioning and heating system, and more particularly, to an air conditioning and heating system filter monitoring apparatus.

In today's society it is sometimes difficult to keep an air conditioning system at top efficiency. This may be caused by various conditions in the air conditioning systems. Sometimes however system inefficiency is caused because of the failure to change the air filters of the unit at appropriate intervals. The air filters of an air conditioning and heating system are provided to remove dirt, dust and other foreign contaminants from the air being circulated through the system. As the air is circulated through the system and the filter catches the contaminants the filter will eventually began to clog thus reducing the volume of air flowing through the system. This in turn causes the air conditioning system to be less efficient and ultimately can cause the system to stop functioning all together.

It is desirable to have a warning system that will alert the person or persons responsible for the air conditioning system as to when it is desirable to change the filter. It is also desirable that such a warning be an audio warning signal which assures that the warning is sufficient to cause the filter to be changed timely.

### BACKGROUND ART

There are a number of filter monitoring systems provided for air-conditioning systems.

One such system is disclosed in U.S. Pat. No. 5,461,368. The system of this invention includes a pair of air pressure sensing probes, one probe being downstream of the blower and filter and the other probe positioned to detect ambient air pressure. This system also includes an air pressure differential sensor which includes a first air pressure differential sensor member adopted to be actuated by a first differential pressure and a second air pressure differential sensor member adapted to be actuated by a second deferential pressure. A control circuit is selectively interconnected between the blower and the first or the second air pressure differential sensor members for interconnecting the first air pressure differential sensor member to the blower when it is operating at a first speed and for connecting the second air pressure differential sensor members to the blower when it is operating at a second speed. A pair of clogged air filter indicating members are provided which are responsive to the actuation of the first air pressure differential sensor member when the blower is being operated at the first speed and responsive to the actuation of the second air pressure differential sensor member when the blower is being operated at the second speed. Although this system provides a reliable method of detecting a clogged filter this system is somewhat elaborate and can be expensive to implement. A less elaborate and more cost effective system is desirable.

Another air filter monitoring system is found in U.S. Pat. No. 5,315,838. The monitoring system of this invention is designed to monitor the conditions of filters in a room air conditioner The monitor assembly of this invention includes a shell mounted on the front of the air conditioner, with an air pressure equalization passage permitting air flow through the shell when a clogged air filter creates a negative air pressure within the air conditioner housing. The shell includes a signal flag which is normally retracted by the force of gravity, but is visibly extended outside the shell by the pressure induced air flow through the shell indicating the air filter is clogged. This system however because of its specific design for a window air conditioner unit cannot be used in the central air and heating system contemplated by this invention.

### DISCLOSURE OF THE INVENTION

A filter monitoring apparatus in accordance with the principles of the invention for use in an air conditioner system includes a means for providing an activation signal. This monitoring apparatus is also provided with a means for sensing air pressure and for determining when the air flowing through the air filter has fallen below a predetermined level. The apparatus further includes a means responsive to the sensing and determining means for accessing the activation signal when the air flowing through the air filter falls below the predetermined level. Additionally, a means is provided for transmitting an audio signal in response to the accessing means so that a predetermined sound is generated when the air filter is clogged.

### BEST DESCRIPTION OF THE DRAWING

The details of the invention will be described in connection with the accompanying drawing in which:

FIG. 1 is a schematic of an air conditioning air filter monitoring apparatus in accordance with the principles of the invention.

FIG. 2 is a block diagram of the air conditioning air filter monitoring apparatus in accordance with the principles of the invention.

FIG. 3 is a circuit schematic diagram of the air conditioning air filter monitoring apparatus in accordance with the principles of the invention.

### BEST MODE FOR CARRYING OUT THE INVENTION

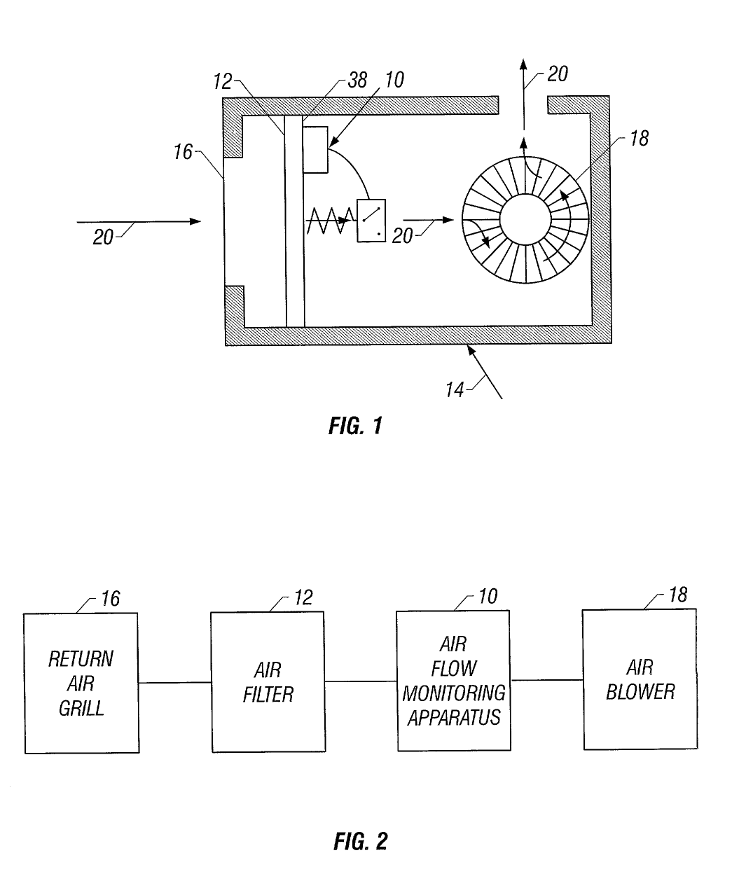

Referring to FIGS. 1 and 2 an air conditioning filter monitoring apparatus, generally designated, by the numeral 10 is provided. The monitoring apparatus 10 is provided to monitor the volume of air flowing through an air filter 12. The air filter 12 is used in an air conditioning and heating system generally designated, by the numeral 14 (only partially shown). The air filter 12 is located adjacent a return air grill 16 between the return air grill and a blower 18 in the return air path 20 of the air conditioning and heating system 14.

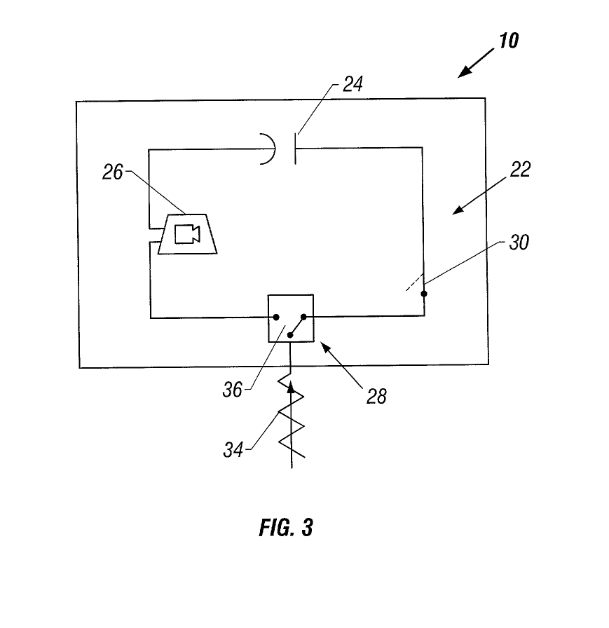

As illustrated in FIG. 3, the filter monitoring apparatus 10 is provided with an actuating circuit, generally designated, by the numeral, 22. The circuit 22 is provided with a power source 24, an auditory warning device or horn 26, an air pressure sensing switch, generally designated, by the numeral, 28, and a manually operated switch 30.

The power source 24 which is provided to supply an activation signal to the horn 26 is electrically coupled thereto through the manually operated normally closed switch 30 and the air pressure switch 28. The air pressure switch 28 includes a spring biased actuating member 34 which electrically interacts with a switch member 36. The air pressure switch 28 can be a standard air pressure switch which can be set to respond to a predetermined air pressure level. At or above this level the switch member 36 is normally opened. The air pressure switch 28 will sense air pressure flowing through the air filter 12. As long as the air pressure is flowing at a predetermined level a sufficient spring tension on the actuating member 34 is maintained thus the switch member 36 is open. If the air pressure falls below the predetermined level the spring tension on the actuating member 34 is released thereby closing the electrical switch member 36. Additionally, the air pressure switch 28 is designed such that the switch member 36 is open when the air pressure is zero which represents those times when the system 14 is completely turned off. This switch is also a variable switch which allows the switch activation levels to be changed as required by the specification of the air conditioning and heating system 14.

As illustrated the filter monitoring apparatus 10 is mountable on an upper cardboard surface 38 of the filter 12 so as not to interfere with the function of the filter and to allow the actuating member 34 to be positioned properly to monitor air flowing through the filter (FIG. 1).

The filter monitoring apparatus 10 is activated when the air volume from the air filter 12 falls below a predetermined level set in the air pressure sensing switch 28. When the volume of air falls below this predetermined level the actuating member 34 causes the switch 36 to close thus closing the electrical path to the horn so that an electrical signal is provided from the power source 24 to activate the horn. Once this occurs the filter 12 should be changed. Once the horn 26 is activated it can be deactivated by opening the manual switch 30.

It should be understood that the air flow monitoring apparatus 10 also functions with the heating apparatus of the air conditioning and heating system 12 by adjusting the level set in the air pressure sensing switch 28 to correspond to the air flow specifications for the heating apparatus.

It should further be understood that various changes and modifications can be made without departing from the spirit of the invention as defined in the claim

What is claimed

1. A filter monitoring apparatus for use in an air conditioning and heating system including:
means for providing an activation signal;
means for sensing air pressure and for determining when air flowing through the air filter has fallen below a predetermined level; means responsive to the sensing and determining means for accessing the activation signal when the air flowing through the air filter falls below the predetermined level; and
means for transmitting an audio signal in response to the signal accessing means so that a sound is generated when the air flowing through the air filter has fallen below the predetermined level thereby indicating that the air filter is clogged.

2. A filter monitoring apparatus as defined in claim 1 wherein the means for providing an activation signal includes a voltage power source.

3. A filter monitoring apparatus as defined in claim 2 wherein the sensing and determining means includes a switching means which is normally open when air pressure is at a predetermined level and is closed when air pressure falls below that predetermined level.

4. A filter monitoring apparatus as defined in claim 3 wherein the switching means includes a spring biased actuating arm which senses air pressure and a switch which electrically interacts with the actuating arm so that the switch closes when the actuating arm senses that air pressure has fallen below the predetermined level.

5. A filter monitoring apparatus as defined in claim 4 wherein the audio signal transmitting means includes a horn which is activated to transmit a predetermined sound when air flowing through the filter falls below the predetermined level.

6. A filter monitoring apparatus as defined in claim 5 further including a means for deactivating the horn once the horn has been activated.

7. A filter monitoring apparatus as defined in claim 6 wherein the deactivating means is a switch.
